(19) United States
(12) Patent Application Publication
(10) Pub. No.: US 2018/0124444 A1
(43) Pub. Date: May 3, 2018

(54) SYSTEMS AND METHODS OF PREDICTING CONSUMPTION OF ORIGINAL MEDIA ITEMS ACCESIBLE VIA AN INTERNET-BASED MEDIA SYSTEM

(71) Applicant: NETFLIX, INC., Los Gatos, CA (US)

(72) Inventors: Roelof van Zwol, Mountain View, CA (US); Christopher Baird Steger, San Francisco, CA (US); Jingu Kim, San Jose, CA (US); Yves Raimond, San Jose, CA (US)

(21) Appl. No.: 15/340,498

(22) Filed: Nov. 1, 2016

(51) Int. Cl. H04N 21/2668; H04L 29/08; H04N 21/442; H04N 21/466; H04N 21/81; H04N 21/45; H04N 21/8352; G06F 17/30

(52) U.S. Cl. CPC H04N 21/2668; H04L 67/22; H04N 21/44222; G06F 17/3053; H04N 21/812; H04N 21/4532; H04N 21/8352; H04N 21/4668

(57) ABSTRACT

A method for determining a subset of users to be shown pre-availability information associated with a new media item is provided. The method includes associating descriptors of a first media item, having a near-zero play-count, in a catalog of an Internet-based media system, identifying a second item having a non-zero play-count, the second item associated with a descriptor of the first item. The method includes collecting pre-availability data describing user interactions with pre-availability elements associated with the first item, the elements being accessible during an intermediate period of time prior to the first item becoming accessible, determining, based on the second item and the collected pre-availability data, a likelihood that a first user will consume the first item, and transmitting a message promoting the first item to a user device of the first user based on that likelihood. Additional systems and methods are disclosed.

### TECHNICAL FIELD

The present disclosure relates generally the distribution of media items including audio and video over a network to a large collection of users who may be permitted to access different media item catalogs.

### BACKGROUND

While consumers may access media items, such as movies and television shows, by receiving over the air signals by subscribing to a cable or satellite television provider, increasingly consumers are accessing more and more content over Internet-based media distribution systems. Some Internet-based media systems allow users to stream content over the Internet to a variety of client devices. For example, a streaming media system may provide content to users via a personal computer, a set-top box, or a personal mobile device, such as a smart phone or tablet computer. Streaming media systems enable users to access media content in a stream, such that the users may begin consuming (e.g., watching and/or listening to) content before the entirety of the content is delivered to the user's client device. Such a system allows users to access content while avoiding a potentially lengthy download process.

In order to provide users with satisfying content, operators of a streaming media system may license content and/or develop high-quality original content for its users to consume. This may entail the creation of a substantial library or catalog of content. A user may access individual media items in the catalog through a process of search and/or by a process of recommendation controlled by the system operator. By helping users to find content that correlates well with the users' personal preferences through searches and/or recommendations, the operator of the streaming media system provides value to its users.

However, problems can arise as the operator of the streaming media system introduces new content for consumption by users via the streaming media system. The express and inferred preferences of users with respect to existing content can drowned out newer content. This may happen, in part, when recommendations are based on user activity data such as reviewing history. Accordingly, the systems that generate the experience of users of streaming media systems is not satisfactory in all respects.

### BRIEF DESCRIPTION OF THE DRAWINGS

FIG. 1 is a block diagram of a streaming media system that allows users to access streaming media items according to some embodiments of the present disclosure.

FIG. 2 is a block diagram of a client device that may be used as part of the streaming media system of FIG. 1 according to some embodiments of the present disclosure.

FIG. 3 is a block diagram of a server device that may be used in the streaming media system of FIG. 1 according to some embodiments of the present disclosure.

FIG. 4 is a diagram illustrating a first media item catalog according to some embodiments of the present disclosure.

FIG. 5 is an exemplary user interface is presented in a personal mobile client device according to some embodiments of the present disclosure.

FIG. 6 is a set of diagrams illustrating rankings that are generating during different periods of a promotion according to some embodiments of the present disclosure.

FIG. 7 is a plot showing the results of multiple models that predict percentages of users likely to watch a newly-launched media item according to some embodiments of the present disclosure.

FIG. 8 is a plot showing a dynamically updated model converging with observed views of the newly-launched media item according to some embodiments of the present disclosure.

FIG. 9 is a flowchart illustrating a method of promoting consumption of a newly-launched media item in a media system according to some embodiments.

These drawings will be better understood by those of ordinary skill in the art by reference to the following detailed description.

### DETAILED DESCRIPTION

With references to the drawings briefly described above, exemplary applications of systems and methods according to the present disclosure are described in this section. These examples are provided to add context and aid in the understanding of the invention. It will thus be apparent to one skilled in the art that the present invention may be practiced without some or all of these specific details. In other instances, well-known process steps have not been described in detail in order to avoid unnecessarily obscuring the present disclosure. Additionally, other applications of the concepts and principles described herein are possible, such that the following examples should not be taken as limiting. For example, while many of the examples disclosed herein are directed to streaming media (audio and/or video), the principles and concepts described may be applied to provide recommendations in a system that additionally or alternatively provides media items for consumption in other manners, such as purchase, rental, download, etc.

In the following detailed description, references are made to the accompanying drawings, which form a part of the description and in which are shown, by way of illustration, specific embodiments of the present disclosure. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for intelligently promoting original or exclusive content made available to the users or a subset of users of an Internet-based media system. For example, the operator of the Internet-based media system may produce or acquire media content, such as an audio album, a television style episodic series, or a feature film length video. When the content is original to the Internet-based media system, there may be a limited amount of data upon which to base recommendations to users with respect to that content. For example, if a new television show is to be distributed in the first instance by the Internet-based media system, there may be no user activity information directly applicable to the new television show. The Internet-based media system may rely partially on information about the new television show and existing content, such as their general subject matter, actors, producers, directors, etc. in effort to relate existing user activity information to the new television show. Additionally, promotional items may be provided to users of the Internet-based media system prior to release of the new television show. For example, a billboard type image may be shown on a landing page on a website or a user interface of an application executing on a user device may be displayed to the user an effort to encourage the user to watch the new television show. Because a limited amount of time and/or area in the user interface may be used for promotion of the new television show, it is advantageous to limit promotion of the new television show, such that not every user is presented with the same promotional material. Additionally, because users have different interests, presenting users of the media system with content that is disinteresting can result in user dissatisfaction.

Embodiments of the present disclosure are directed to collecting user interactions associated with pre-availability elements (elements promoting the new television show that are accessible before the new television show itself becomes accessible and that may remain accessible even after the new television becomes accessible) and utilizing those interactions to determine what users should be presented with promotional messages such as the pre-availability elements. For example, because certain users interact with pre-availability elements at a given rate, similar users may be presented by the media system with those pre-availability elements at a higher rate. Users that are likely to be uninterested in viewing the media item may also be identified so that other pre-availability elements or elements promoting media items launched on the media system at least several months ago may be presented to those users instead. Further, the media system may determine another group of users to whom the pre-availability elements or other promotional messages should be presented in order to communicate uniquely available content associated with the media item.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these words are not necessarily all referring to the same embodiment. Furthermore, the particular features, structures or characteristics may be combined in any suitable manner in one or more embodiments.

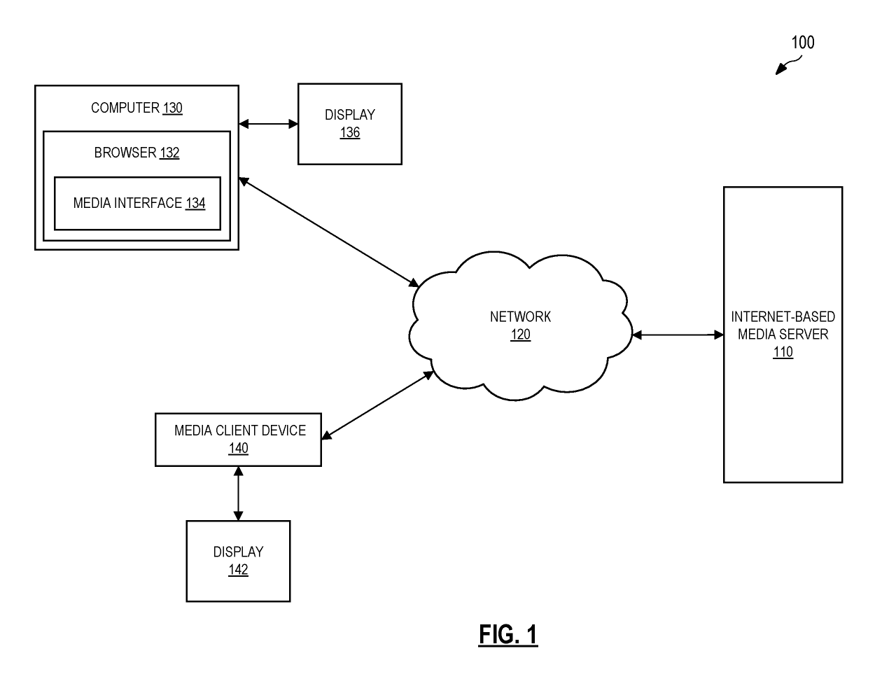

Referring now to FIG. 1, shown therein is a block diagram of an Internet-based media distribution system 100, or simply. Many embodiments of the media system 100, as described herein, provide users with access to streaming media items. However, additional embodiments of the media system 100 as described herein additionally or alternatively provide users with access to downloadable media items. The media system 100 includes a media system server 110 that is illustrated in communication with multiple client devices over a network 120. The media system server 110 may comprise or implement a plurality of servers and/or software components that operate to perform various operations in accordance with the described embodiments. Exemplary servers may include, for example, stand-alone and enterprise-class servers operating a server operating system (OS) such as a MICROSOFT® OS, a UNIX® OS, a LINUX® OS, or another suitable server-based operating system. It can be appreciated that the server 110 illustrated in FIG. 1 may be deployed in other ways and that the operations performed and/or the services provided by such servers may be combined or separated for a given implementation and may be performed by a greater number or fewer number of individual server devices. One or more servers may be operated and/or maintained by the same or different entities. As illustrated, the server 110 is operated by an Internet-based media service provider, also referred to herein as a media system operator.

Data and/or voice communications between the client devices and the media system server may be sent over the network 120 which may include one or more networks such as the Internet, a WAN, a WWAN, a WLAN, a mobile telephone network, a landline telephone network, a VoIP network, as well as other suitable networks.

The media system 100 may further include a streaming media interface 134 operating on computer 130, a client device that can communicate with the media system 100 over the network 120 to access downloadable or streamable media items. Embodiments of the computer 130 may include one or more types of client devices, such as a personal computer, a laptop, a set-top box, a mobile-computing device, such as tablet computer or a smartphone, a wearable computing device, and/or any other computing device having computing and/or communications capabilities in accordance with the described embodiments. The computer 130 includes a processing device and data storage device or memory and is able to execute instructions corresponding to system programs and application programs to perform various computing and/or communications operations. Exemplary system programs may include, without limitation, an operating system (e.g., iOS®, Android® OS, LINUX® OS, Firefox OS™, Windows®, OS X®, iOS®, Android®, and others), device drivers, programming tools, utility programs, software libraries, application programming interfaces (APIs), and so forth. As shown in FIG. 1, the computer 130 executes software to provide a browser 132. The browser 132 may be a web browsing program such as Internet Explorer®, Chrome®, etc., and in turn, the browser 132 may be provided as part of a specific streaming (or downloadable) media interface 134 provided by the media system operator. In some embodiments, the streaming media interface 134 may be a separate application executed independently of the browser 132 or the browser 132 may be an application other than a web browser, such as a custom application enabling users of the computer 130 to access content from the media server 110. When executing the browser 132 and/or the streaming media interface 134, the computer 130 renders information for presentation in a display 136. In various embodiments, the display 136 may be integrated with the housing of the computer 130 or may be physically separate therefrom but coupled thereto by a wired and/or a wireless communication link.

The media system 100 further includes a specialized media client device 140 coupled to a display 142. For example, the media client device 140 may be a set-top box designed and configured to communicate directly with a display 142 and with the media system server 110. For example, the media client device 140 may be an Apple TV® device or a media player made by Roku, Inc. of Saratoga, California. In some embodiments, the media client device 140 may be integrated with the display 142 in a “smart” television. In operation, the media system 100 permits the media system server 110 to receive requests for content from users operating the computer 130 and/or the media client device 140 over the network 120 and to provide streaming media items over the network 120 in response. The information received from the media system server is rendered to the displays 136 and/or 142 in one or more graphical user interfaces.

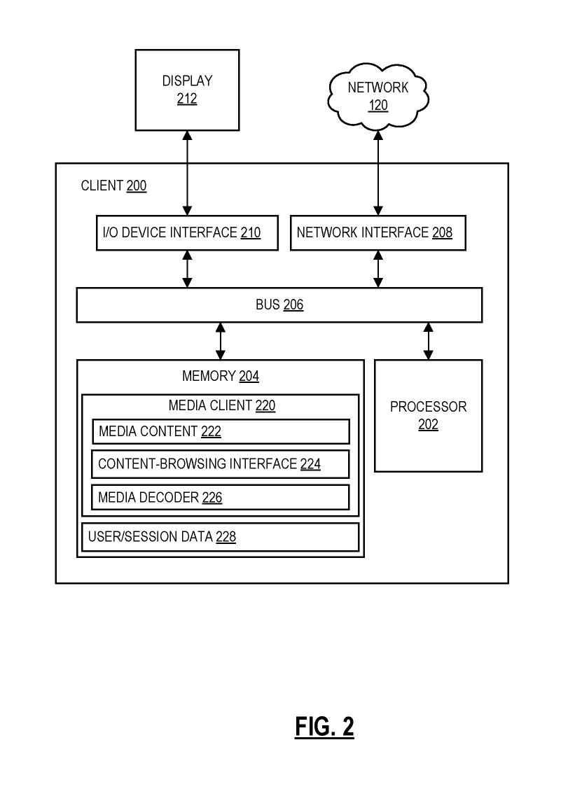

Referring now to FIG. 2, shown therein is an exemplary embodiment of the computer 130 and/or the media device 140, represented as a client device 200. The client device 200 includes a processor 202 in communication with a data storage device or memory 204 over a bus 206. The bus further couples a network interface device 208 and an I/O device interface 210. The network interface device 208 may be a network interface card or network interface controller (NIC) that permits the client device 200 to communicate with the network 120. The I/O device interface 210 enables the client to communicate information to be rendered to the display 212 to display streaming media items and/or graphical user interfaces associated therewith. The I/O device interface 210 may further communicate with I/O devices such as infra-red (IR) or radio-frequency (RF) remote controls, keyboards, mice, touchscreens, etc. The processor 202 may execute software and/or other instructions stored in the memory 204. The memory 204 may be a collection of memories of different types that are included in a housing of the client device 200 or coupled to the client device 200 and in communication therewith. For example, the memory 204 may include cache memory, RAM, ROM, a solid-state hard drive, a disk-based hard drive, and/or other memory devices. The features depicted as stored on the memory 204 may be stored on and/or accessed from any combination of these different types of memories.

As illustrated in FIG. 2, the memory 204 includes a media client 220, which may be a program executed by the processor 202 to provide a client configured to communicate with the media system server 110 of FIG. 1. The media client 220 may have associated information stored in the memory 204. This is associated information may include offered media content 222, the content browsing interface 224, and a media decoder 226. The media content 222 may include a buffered portion of a streamed media item or, in other embodiments, one or more downloaded media items. These associated modules or components enable the media client 220 to provide a graphical user interface by which a user may receive recommendations, make selections of media items to play, and play selected items.

In streaming embodiments, as a media item is received by the client device 200, the data representing a portion of the media item may be stored temporarily in a buffer. After the buffer contains sufficient data to provide for continuous streaming, the content may be rendered by the media decoder 226. The memory 204 further includes a user/session data 228 that may include information regarding interactions between the user of the client device 200 and the media system server 110 of FIG. 1 during a session. For example, the user/session data 228 may include user activity data regarding selections made by the user and/or presentations to the user made by the media system server 110. Additionally, the user/session data 228 may include information regarding the transmissions between the client device 200 and the media system server 110 including an average throughput and/or a peak throughput. Further, the user/session data 228 may include information specifying an average bit rate associated with the streams that deliver the media items. In this way, an appropriate bit rate stream may be selected for subsequent portions of a media item or when a user selects a new media item to play.

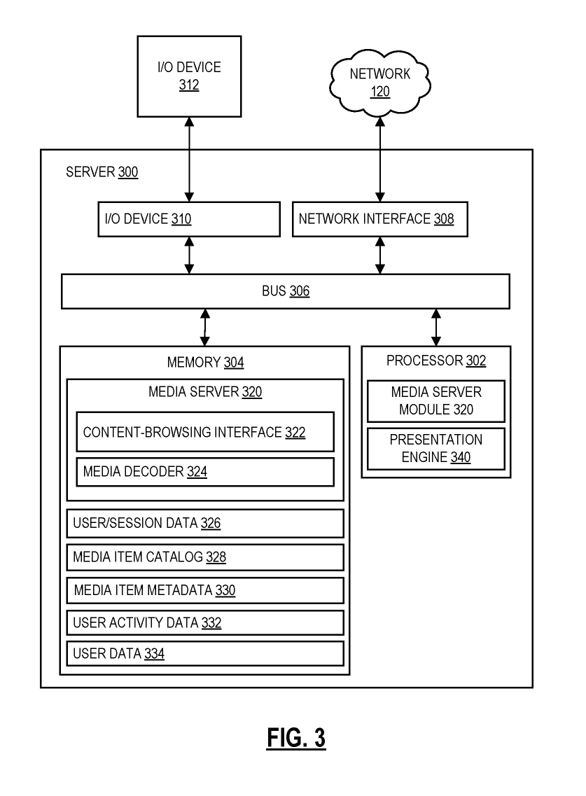

Referring now to FIG. 3, shown therein is a server 300 which may provide the server 110 of FIG. 1 as described herein. The media system server 300 is illustrated according to some embodiments of the present disclosure. As illustrated, the server 300 includes a processing device or processor 302, such as a central processing unit (CPU), a microcontroller, etc. The processor 302 is in communication with a memory 304 over a bus 306. The bus further connects the processor 302 to a network interface 308 and an I/O device interface 310. As described above in connection with client device 200 of FIG. 2, the network interface 308 may be a network interface card or a network interface controller (NIC) that enables the server 300 to communicate over a network 120 with multiple devices, such as client devices and other servers and/or media storage devices. The I/O device interface 310 couples the server 300 to one or more I/O devices such as the I/O device 312. The I/O device 312 may be a display, a keyboard, a mouse, a touchscreen, etc.

The processor 302 retrieves and executes programming instructions stored in the data storage device or memory 304 and may further access data stored therein when executing programming instructions to provide operations as described herein. While the memory 304 is illustrated as a single memory 304, the memory 304 may be a collection of memory types and devices. For example, the memory 304 may include cache memory, RAM, ROM, solid-state devices, magnetic disk-based storage devices, etc. In some embodiments, the memory 304 may further include networked-based storage, including a storage area network (SAN). For example, the information that is provided to users as a streamed media item may be stored in memory that is not housed within the housing of the server 300. The server 300 may be part of a content distribution network and so may be housed in a data center used to provide media item access to users.

When a media item is selected by a user, the server 300 may access the media item wherever it is stored in memory in order to provide the media item to the user through the network interface 308 over the network 120. This may be done by the media server module 320 which, as illustrated is stored in memory 304 and executed by the processor 302. The media server module 320 includes instructions for providing a content browsing interface 322 and a media decoder 324, which may be used to decode and/or encode media items as they are received from storage and provided to a user over the network 120.

The memory 304 further includes a user/session data 326, which may be a set of information associated with each user's current session. For example, the user/session data 326 may include a bit rate that characterizes the connection with the user's client device to enable the appropriate selection of audio/video data to be sent to the user. Different portions of the information associated with the user/session data 326 may be moved to other databases during or after a session. The media item catalog 328 may be stored in the memory 304 and may constitute a media item catalog or a plurality of media item catalogs accessible to one or more users of a streaming media system. Each of the media items represented in the media item catalog 328 may be accessible in a plurality of bit rates. An appropriate bit rate stream of the media item may be selected by the server 300 or the client device 200 when the media item is selected by the user. Associated media item metadata 330 may be stored on the memory 304 in connection with the streaming media items. The metadata 330 may include information about the media items, such as titles, durations, genres, play counts (by user, by jurisdiction, or in total), indications of whether or not the media items have been presented to a particular user, in which jurisdiction the media items are available, availability dates, etc. Alternatively, the media item catalog 328 may include the metadata 330 describing the actual media files, which may be made available from a content distribution network. In such a case, the media server module 320 may be configured to generate a permission used by a client to obtain a given streaming media item from the content distribution network and to direct a client to the streaming media item wherever it is to be accessed. In some embodiments, the content distribution network is operated by a party that is not the operator of the streaming media system. Thus, in some embodiments, the content distribution network is a third-party system.

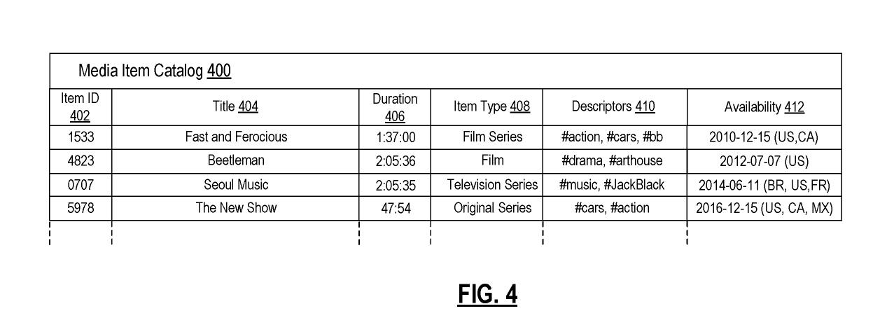

An exemplary embodiment of the media item catalog 328, referred to as a media item catalog 400, is shown in FIG. 4. In the depicted embodiment, each media item included in the media item catalog includes a unique media item ID 402, a title 404, and a duration 406. The media item ID may be automatically generated when a media item is encoded and stored in the media item catalog 400. The title 404 may be added at that time and the duration 406 may be automatically determined from the file including an instance of the particular media item. Additionally, the media item catalog 400 includes an item type 408, which may indicate a type of the media item, e.g. a television series or other episodic format, a stand-alone film, a film series. The item type 408 may also be an “original” series or “original” film. By “original,” it is meant that the media item has not been publicly available via any other media distribution system, such as over the air television, subscription-based television (e.g., cable or satellite television), or distribution in movie theaters. For example, media item #5987, entitled “The New Show,” is an “original series,” meaning that the content is unique to the media system 100 or unique to an operator of the media system, such as Netflix, Inc. of Los Gatos, Calif. Because the media item is not or has not been available to consumers via other distribution channels, direct market information may be unavailable, which may complicate attempts to determine the likelihood that any given user will consume the original media item.

The media item catalog 400 further includes tags or descriptors 410. For example, the media item #5987 is associated with descriptors “cars” and “action”. Other descriptors in the media item catalog may identify an actor or director, etc., associated with the particular media item. The descriptors may provide a degree of relatedness or association between two or more media items in the media item catalog 400. For example, the media items #4978 and #1533 both include descriptors of “cars” and “action.” Prediction algorithms may rely on these overlapping descriptors to relate information about media item #1533, such as related user activity data, with the media item #5978, such as for making predictions as to the likelihood that a particular viewer that viewed media item #1533 is likely to view media item #5978.

The media item catalog 400 may further include availability information 412. The availability information may include an availability date indicating when a media item was added to the media item catalog. The availability information 412 may also include geographic or jurisdictional information, such as information identifying countries in which the particular media item is available. In some embodiments, the availability information 412 may include multiple availability dates associated with multiple jurisdictions. In some embodiments, the media item catalog 400 may include multiple media item catalogs that are associated with individual jurisdictions and or tiers of access.

Returning to FIG. 3, the media item metadata 330 may also include information describing or characterizing which catalog of a plurality of catalogs each user may access and/or a media item groups with which a user is associated in some degree. Associated groups of users and/or groups of media items may be identified by the media system server 300 from the media item metadata 330. For example, groups of media items may be thematically related such as “action movies,” or “true crime television shows,” etc. In some embodiments, the groups of media items may be related in ways that are not thematic, such as media items related by actor, by producer, by year, by geography or jurisdiction, etc. The metadata 330 may include such descriptors for each media item in the media item catalog 328. In some embodiments, machine learning is used to identify tags or descriptors to be associated with the media item. For example, the visual aspects of explosions may be observed by a machine learning process and a descriptor “action” or “explosion” may be generated and associated with the media item. Additionally, descriptors may be associated with media items based on human categorization. Media items may be associated with a plurality of descriptors or tags, such that multiple associations may be detected between media items and/or groups of media items.

User activity data 332 is representative of one or more log files and/or databases in which user/session data is stored, including data relating to activities undertaken by users. Such activities may include, e.g., selecting a media item, playing a media item, performing a search, selecting a recommended media item, searching for a media item, a promotional media item such as a promotional image or video, and the like. Thus, user activity data 332 may include, e.g.: a user identifier (ID), media item IDs of media items presented to the user as recommendations, media item IDs of media items selected or played by the user, promotional item IDs that can be associated with the underlying media items being promoted thereby, timestamps of when the item was recommended and/or selected, of pauses (intentional or unintentional) that occurred during play, of when selected items end playing. Aspects of the user activity data 332 may associate particular users or groups of users with particular types of media items, based on tags or descriptors associated with those media items. Such information may be included in the user data 334. The memory 304 further stores the user data 334, which may also include user IDs of each user subscribing to the streaming media system or otherwise having access thereto, and may further include usernames, password data, and other user information, such as profile information. Some or all of the user data 334 may be encrypted or otherwise processed to protect user privacy. For example, some types of user data 334 may be stored in a different component of the memory 304 than others or in a different service or data center. In some embodiments multiple profiles may be associated with a single user ID. For example, a user ID may be used by all the members in a household, while some subsets of the members of the household may have different profiles. For example, a user ID may be associated with a children's profile and an adult's profile.

The user activity data 332, media item metadata 330, and user data 334 may be used to identify causal and non-causal relationships between activities of various users and particular media items or groups or clusters thereof and relationships between the various users and the media system itself. For example, the user activity data 332, media item metadata 330, and user data 334 may be used to determine the likelihood or probability that a user or group of users will select a particular media item when that particular media item is presented to the user or cluster of users or when a related promotional media item is presented to the user. For example, when a user browses the media item catalog 328, or a subset thereof that is accessible to the user, the user may be presented with a promotional media item, such as a trailer associated with a full length media item such as a television episode or a movie. In some instances, this associated promotional media item may be accessible to the user before the associated full length media item. Under such circumstances, the promotional media item may be referred to as a pre-availability element, because it is accessible to the user before the associated full length media item is available to that user. It should be noted that pre-availability elements may also be presented and accessible to the user even after the associated full length media item becomes available to that user. A media item may become available to a user based on a release date, a level of service, etc.

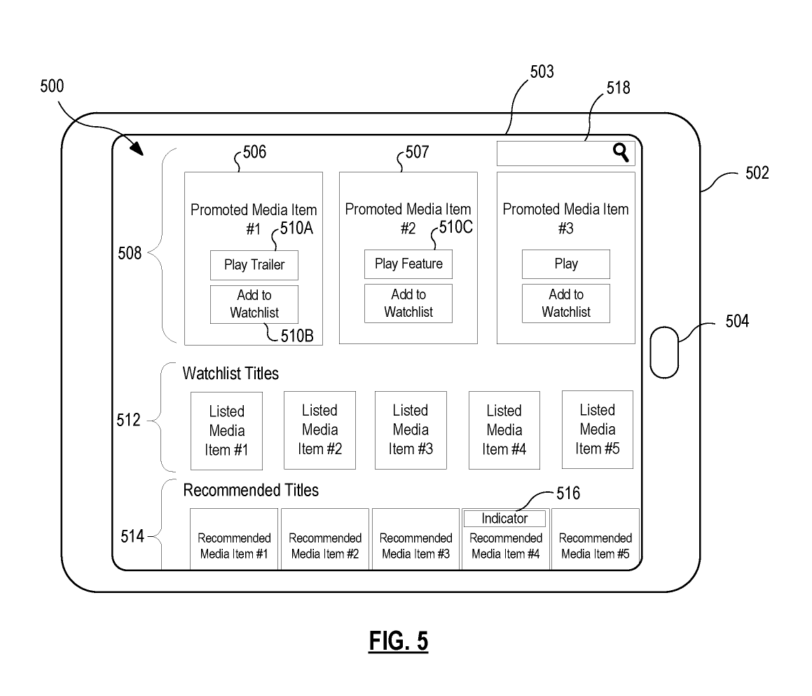

FIG. 5 depicts an exemplary user interface 500 rendered in a display screen of a user device 502 to present media items from the media item catalog 328 for consumption by a user of the media system 100. The user device 502 may include input elements, such as the button 504, which may be a mechanical button, a capacitive button, or some other input means. The user device 502 may include a touchscreen 503 through which input may be received from the user of the user device 502. For example, a user may tap or touch on a UI element to select or activate that element. Alternatively, the user may interact with the user interface 500, including for example making selections and inputting commands, using a different input interface such as a keyboard, mouse, remote control, or voice interface. The user device 502 of FIG. 5 may be an implementation of the computer 130 of FIG. 1 and the client device 200 of FIG. 2.

The user interface may vary in many respects, some of which may depend on the user device 502 and/or on expressed preferences of the user. As illustrated, the user interface 500 includes one or more pre-availability elements 506 along a row 508 of promoted media items. For example, the promoted media item #1 includes an exemplary pre-availability element 506, which may be an image, such as a still image associated with a media item being promoted to the user by the display in the user interface 500. The promoted media item #2 may be an image 507 representing a media item that has been available via the media system 100 for a period of time.

The still image included in the pre-availability element 506 may be a still image captured from the underlying media item, a brief clip from the underlying media item, original image developed to promote the underlying media item, etc. The pre-availability element 506 may also be, for example, a slideshow including multiple such images in a sequence or a video, or any combination of these. In some implementations, the pre-availability element 506 may include user interface elements 510, which include UI elements 510A and 510B in the depicted implementation. Similarly, the image 507 (associated with the promoted media item #2) may include a UI element 510C to permit a user to request that the promoted media item #2 be played.

The pre-availability element 506 may be an interactive feature of the user interface 500, such that selection of the pre-availability element 506 may provide the user of the user device 502 with additional information regarding the associated media item. Interaction with the pre-availability element 506, such as selection thereof via the user device 502, may be included in the user activity data 332, as discussed herein. The UI elements 510 may also be considered pre-availability elements because they are associated with an underlying media item. Further, selection of the UI element 510A may cause the user device 502 to access a trailer or clip of the underlying the media item. For example, if the underlying media item was “The New Show” included in the exemplary media item catalog 400, a user selection of the UI element 510A may cause a trailer associated with “The New Show” to be accessed from the media system server 110 by the user device 502. In some implementations, the trailer or clip associated with a given media item may be stored in a separate media item catalog, e.g. separate from the media item catalog 400. Selection of the UI element 510B may cause the underlying media item to be added to a watch list of the user of the user device 502.

As shown in FIG. 5, the user interface 500 includes a plurality of media items from the user's watchlist 512. Accordingly, a user may select the UI element 510B to add the promoted media item #1 to watchlist 512. Inclusion in watchlist 512 may be permitted even for items that are not yet available for viewing. When the underlying media item becomes available, the user may select it from the watchlist 512 for viewing. Interactions with the UI elements 510 may be counted and recorded as interactions with pre-availability elements in the user activity data 332. Further, the presentation of pre-availability elements 506 and 510 may be recorded in the user activity data 332, regardless of whether or not the user interacts with them.

The user interface 500 may further include a list 514 of recommended media items. The list 514 may include items recommended by the presentation engine 340 for the user of the user device 502. The recommendations in the list 514 may be based on user activity of the individual user or of a group of users with which the individual user is associated. As shown in FIG. 5, the recommended media item #4 includes an indicator 516. The indicator 516 may include graphical and/or textual content. For example, the indicator 516 may say “Available in 5 Days!” or simply “5 Days” or “Newly Added.” Such messages may be displayed in connection with the underlying media item whether it is included in the graphical user interface 500 in connection with a promoted media item in the row 508, as a listed media item in the watchlist 512, or a recommended media item in the list 514.

Some embodiments of the user interface 500 may include search field 518, into which the user may enter information to perform a search of the media item catalog. Entry of a search term or search image into the search field 518 may cause a search to be performed based on titles, descriptors, or other identifying elements associated with media items. The user activity data 332 may include a search history of each user. For example, if a user searches for “The New Show” or “New Show,” the user activity data 332 may be used by the presentation engine 340 in predicting the likelihood that the searching user will consume the media item entitled “The New Show.” Searches performed within the search field 518 may be included as interactions with pre-availability elements in the user activity data. In some embodiments, searches may be reviewed from a time period preceding the intermediate time period during which pre-availability elements are intended to be presented to users. For example, information regarding “The New Show” may become available to the public before a campaign to promote “The New Show” is begun by the operators of the media system server 110. Under such circumstances, users may begin searching for “The New Show” before other pre-availability elements (e.g., a trailer) becomes available via the media system server 110. Thus, the presentation engine 340 may interpret any searches for “The New Show” that occur in the pre-availability period and any such searches that occur in the intermediate and availability periods. The searches may constitute interactions with pre-availability elements associated with the media item entitled “The New Show.”

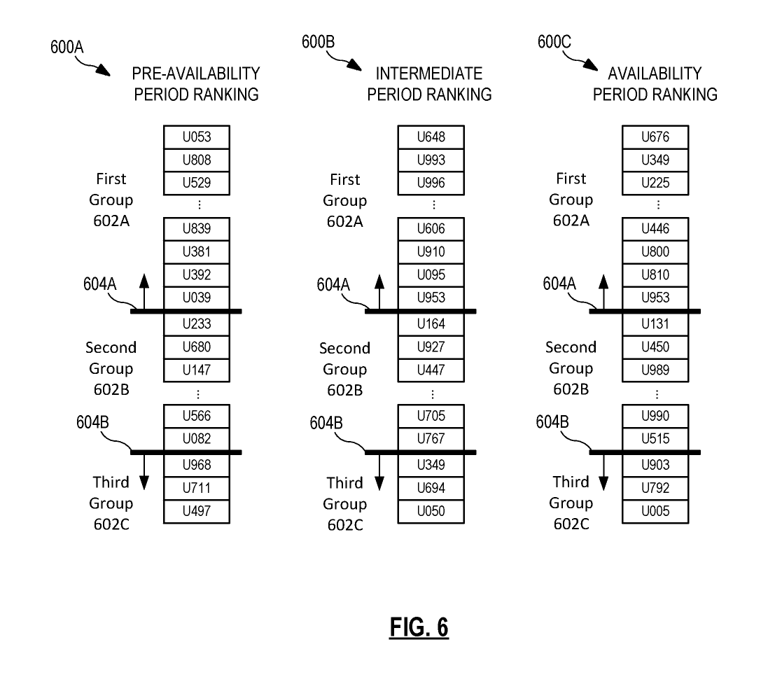

Returning to FIG. 3, the server 300 further includes a presentation engine 340, which determines which media items from the media item catalog 328 and which pre-availability elements should be recommended or presented to a particular user in a user interface, like the user interface 500 of FIG. 5. The presentation engine 340 may determine which promoted media items and which recommended media items should be included in the user interface 500. To accomplish this, the presentation engine 340 may access information stored in the media item catalog 328, the media item metadata 330, and/or the user activity data 332. In some embodiments, the presentation engine 340 may generate one or more rankings of users of the media system server 110 based on the likelihood that each user will consume a particular media item. This ranking may be updated periodically or dynamically. FIG. 6 depicts exemplary rankings 600A, 600B, and 600C, collectively referred to as ranking 600. The ranking 600 may be generated by the presentation engine 340 and are associated with different periods associated with a specific media item, such as “The New Show,” from the exemplary media item catalog 400 of FIG. 4. For example, the ranking 600A is associated with a pre-availability period, a period in which a particular media item is unavailable to users of the media system server 110 and in which pre-availability elements are also not presented to users of the media system server 110. The ranking 600B is associated with an intermediate or intermediate availability period, a period in which pre-availability elements associated with the particular media item are available to users of the media system server 110. The ranking 600C is associated with an availability period during which the particular media item is available to users of the media system server 110 in addition to the pre-availability elements associated with the media item. In this way, the pre-availability elements may be presented to certain subsets of users, based on the rankings 600A-C during the intermediate period and the availability period. After the availability period the pre-availability elements may no longer be presented in some embodiments. This may be referred to as a post-availability period. During the post-availability period pre-availability elements like pre-availability element 506 may no longer be presented to the user. However, an image, like the image 507, or another UI element associated with the underlying media item may be presented as a search result or based on other recommendation criteria in the post-availability period.

Each of the rankings 600 ranks a set of users that will have access to a media item at a known time. For example, “The New Show” may be scheduled to become accessible to users of the media system server 110 (or subsets of global users in the United States, Canada, and Mexico) on Dec. 15, 2016. The intermediate period ranking 600B may be a promotional period during which pre-availability elements are displayed to users in order to increase awareness of and promote viewing of “The New Show.” The length of the intermediate period ranking 600B may vary from a week to a month or more, and may vary for each media item being promoted. The pre-availability period ranking 600A defines time before the availability of the pre-availability elements. As an example, the availability period ranking 600C may begin at day 0, while the intermediate period ranking 600B includes days −7 through −1, and the pre-availability period ranking 600A may end with day −8. Other embodiments may measure days from another point and may include more days in the intermediate period ranking 600B.

As shown in FIG. 6, the rankings 600 may be determined based on the likelihood of users to view a promoted media item, like “The New Show.” The probabilities may be determined by the presentation engine 340 of FIG. 3 based on information about the users and information about the promoted media item. For example, an initial likelihood may be determined based on the descriptors (“cars” and “action”) associated with the promoted media item (“The New Show”). This may provide the media system server 110 with an initial rough prediction. The users may be separated into multiple groups 602, collectively, depending on their probability of consuming the promoted media item. In the depicted embodiment, three groups of users are illustrated. Other embodiments may include more or fewer groups. These 3 groups (first group 602A, second group 602B, and third group 602C) may be determined based on two thresholds 604A and 604B. The upper threshold 604A may separate a target group (first group 602A) from a reach group (second group 602B). The target group 602A represents a group that is very likely to view the particular media item when it becomes available. For example, the target group 6028 may be defined as the group of users having a probability of consuming the media item that exceeds 75%, which would then be the upper threshold 604A. The upper threshold 604A may be lower or higher in some other embodiments. The second group 602B may include users having a probability of consuming the particular media item that is less than the upper threshold 604A but is greater than a lower threshold 604B. This reach group 602B may include users to whom pre-availability elements associated with a particular media item should be shown less frequently than to the users of the target group 602A.

The third user group 602C, those users having a likelihood below the lower threshold 604B, may be users to whom no pre-availability elements associated with particular media item should to be shown. For example, because a user in the group 602C dislikes content similar to the particular media item, as determined based on the descriptors of the media item, related media items, and user activity data associated with the user, the presentation engine 340 may determine that presenting associated pre-availability elements would be counterproductive. The presentation of associated pre-availability elements may be counterproductive in that the user is determined to be likely to dislike the media item or the presentation may be counterproductive in that it would displace promotion of media items that the user is more likely to enjoy and watch.

During the intermediate period ranking 600B, the users in the first group 602A and the second group 602B may change based on user interactions with the pre-availability elements associated with the particular media item for which the ranking is developed and maintained by the presentation engine 340. For example, the presentation engine 340 may process user activity data 332 to determine that users with a demonstrated affinity for media items tagged with the descriptor “cars” have interacted with pre-availability elements at a statistically higher rate than those who interact with media items tagged with the descriptor “airplanes,” and may update the ranking 600B based on that observed user activity data. Such descriptors may be latent descriptors used within the media system 100. The presentation engine 340 may begin to weigh that factor more heavily in predicting the likelihood of users for inclusion in the target group 602A. During the intermediate period ranking 600B, the ranking 600B may be updated periodically, such as weekly, daily, or every 12 hours. The ranking 600C may be updated at a similar rate or at a different rate than the ranking 600B. After the media item becomes available, i.e. the availability period ranking 600C has begun, users that have consumed the media item may be excluded from the ranking 600C. Accordingly, the number of users included in the rankings 600A, 600B, and 600C may be different and may be progressively smaller.

The presentation engine 340 may use many different models in determining the likelihoods associated with each of the users in the rankings 600. The presentation engine 340 may operate so as to maximize multiple objectives. For example, the presentation engine 340 may be programmed to maximize accuracy of the first group 602A, such that few members of the target group 602A will not consume the media item within a particular period of time during the availability period ranking 600C. The period of time may be 1 day, 15 days, 30 days, 45 days, etc. The presentation engine 340 may also be programmed to operate so as to maximize the total number of watchers or consumers of the media item. This may be done by more heavily promoting or presenting pre-availability elements to users in the second group 602B. However, the presentation engine 340 may be programmed with both goals (minimizing the error of the likelihood prediction and maximizing the total number of watchers), in some embodiments. A user that has consumed the media item may be referred to as a “watcher” of that item.

In some implementations, a user that consumes a certain percentage of the media item may be considered to be a watcher even if that user does not consume all of that media item. For example, a user may be considered to be a watcher if the user has consumed 70% of the media item, i.e. user activity data indicates that 70% of the duration of the media item has been transmitted to the user device of the user. The portion or percent of a particular media item may vary based on the type of media item, e.g., a television-type episode, a feature-length movie, etc.

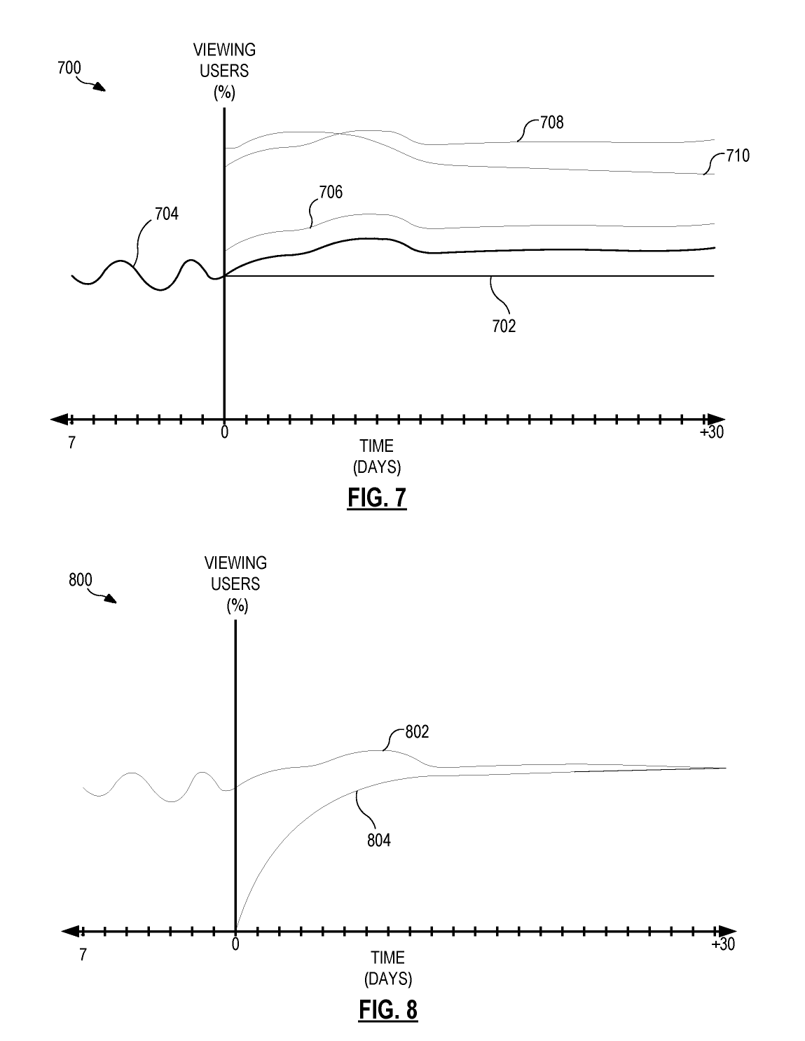

FIG. 7 shows a plot 700 with results of several predictive models that may be used to predict the percentage of potential consumers of the media item introduced on the media system server 110. This prediction may be used in the calculations of the first and second thresholds 604A and 604B, which may be used to determine a promotion level associated with rank users, as discussed above in connection with FIG. 6. In some embodiments, the models depicted in the plot 700 may be used to determine the second threshold 604B, which may determine the set of users to whom pre-availability elements (which may be referred to as promotional elements after availability begins at day 0) should be shown in the user interface 500. The simplest model that may be used in embodiments of the present disclosure is a fixed model 702, which sets a fixed percentage of users to whom promotional elements should be shown during the availability period. The model 704 may be an adaptive model that uses collected user activity data to adjust one or both of the thresholds 604, thereby adjusting the percentage of users to whom promotional elements will be presented. In some embodiments, the model 704 may be produced by combining one or more separate models. For example, the model 704 may be composed of a first model before day 0 and a second model after day 0.

Because two goals of precision in promoting a particular media item and increasing overall consumption of that particular media item may conflict, additional models may be used. For example, the model 706 may be based on the dynamic model 704 and further include a padding value or padding percentage above the results of the dynamic model 704. For example, the model 706 may include a padding value of 5%. The model 708 may be a fixed multiple of the model 704, such that when the model 704 indicates promotional items should be shown to 30% of eligible users (users in a jurisdiction in which the media item has not launched may be excluded), the model 708 may indicate that the associated promotional items should be shown to 50% of users (multiplier of 1.67) or to 60% of users (multiplier of 2). Other multipliers may be used that increase or decrease the results of the model 704. The model 710 may include a level of padding relative to the model 704, like the model 706. Additionally, the model 710 may include a confidence based parameter, which may be based on the variance in the accuracy of the prediction interval of users. The model 710 would provide a larger group of users for the initial promotion after launch, and may decrease thereafter due to the confidence based parameter.

As noted above, the model 704 may include one than one model. The first model (the first portion of the model 704 as shown) may be combined with one of the other models 702, 706, 708, or 710, in other embodiments. Other models may be included in embodiments of the media system server 110. For example, some models may include padding levels that change at certain times after launch or multipliers that change periodically or dynamically. For example, a first multiplier may be applied during the first week after launch, and each week thereafter the multiplier may be decreased by a stepped amount. Tree-based models may be used to capture nonlinearity and interactions in this feature space. For example, a decision tree can be employed to learn non-linear relationships and interactions between the different features by (repeatedly) splitting positive and negative samples at any point in the decision tree. As such tree-based models may facilitate learning distinctions between pre- and post-launch behavior. Some additional models, such as linear regression, may require such interactions to be engineered explicitly, and even then are may be less effective. Additional models may include regression models, such as quantile regression or beta regression.

Any combination of the models included in the plot 700 may be utilized by the media system server 110 simultaneously, such that different models are applied to different groups of users. For example, the model 704 may be utilized to determine the presentation of pre-availability elements to a first set of users while the model 710 may be utilized to determine the presentation of pre-availability elements to a second set of users. The user activity data from these 2 sets of users (or from more sets of users when more models are employed by the media system server 110) may be compared to determine which model more accurately corresponds with actual consumption of the media item being promoted at launch. In some embodiments, based on results obtained from the different models during a short time period, such as a week or 2 weeks, one or more models may be eliminated from use and replaced with one of the remaining models.

Model 704 includes pre-launch data in the form of user activity data describing interactions with pre-availability elements, such as trailers, images, and requests to include the yet-to-be-launched media item on a watchlist of the user. This prelaunch data may be used by the model 704 to predict the likelihood of users to watch the media item upon release. User activity data describing user interactions with pre-availability elements may be used in connection with any predictive models used by the presentation engine 340. Such user interactions may occur during an intermediate period as well as during an availability period.

The plot 700 may represent models association with a specific jurisdiction or subset within the global set of users of the server provider that operates the media system server 110 of FIG. 1. For example, the plot 700 may be associated with a single country, such as the United States or Brazil. In other words, the predictive models shown in plot 700 may provide for different results based on the country of a user. The functions underlying the models of the plot 700 may receive a country designation as an input. Accordingly, the models may be global models that produce country specific predictions based on the inputs received.

As shown in FIG. 8, the plot 800 demonstrates that a model 802 converges with the actual observed percentage 804 of viewing users after a certain period of time. In this way, the reach of a promotional campaign may be frontloaded to increase consumption of the launched media item within a given timeframe after its launch, e.g., 30 days after launch. As the model of predicted viewing users receives more data, the model may converge with the actual viewings or consumptions included in the user activity data. Promotion of the media item may then be switched over to a recommendation algorithm that makes recommendations for users based on their activity and preferences and based on metadata associated with the media item catalog.

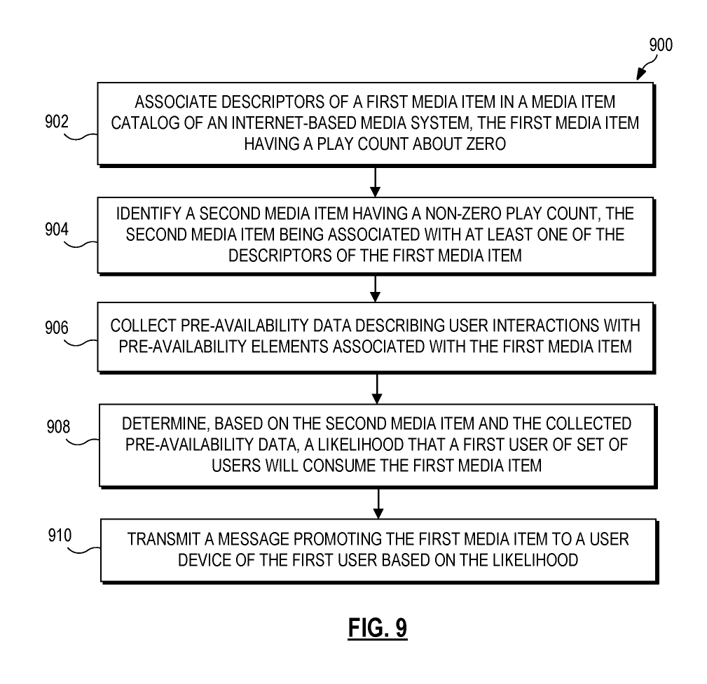

FIG. 9 presents a flowchart of a method 900 that may be implemented by the presentation engine 340 of FIG. 3 within the context of the media system server 110 of FIG. 1. The method 900 is depicted as a series of enumerated steps or operations. Embodiments of the method 900 may include other operations between, after, as part of, or in addition to the enumerated operations. Some embodiments of the method 900 may not include all of the enumerated operations. Additional embodiments of the method 900 include a set of instructions stored in a non-transitory computer readable medium that when executed by a processor, cause the processor to perform the operations of the method 900.

Embodiments of the method 900 may begin at operation 902 in which associating descriptors of a first media item in a media item catalog of an Internet-based media system. For example, “The New Show” (media item #5978 in media item catalog 400 of FIG. 4) may include descriptors “cars,” “action,” “Dwayne_Johnson”, “Michael_Bay” and others associated with this media item in metadata, like the metadata 330 of FIG. 3. As indicated in the metadata associated with “The New Show,” the availability date for the media item is a future date, Dec. 15, 2016. The metadata 330 may further include a play count associated with “The New Show.” This play count may be exactly zero or may be about zero. A play count of about zero may include a relatively small number of play counts that are generated during the process of adding the media item to the media item catalog. For example, testing may be done to ensure the media item performs as expected. Associated testing may result in a play count that is not exactly zero, but is an effectively equivalent count that is close to zero. Accordingly, portions of the play count attributable to any testing may be ignored for purposes of the method 900.

At operation 904, a processing device of an Internet-based media system may identify a second media item (or multiple second media items) having a non-zero play count. The second media item may be associated with at least one of the descriptors of the first media item. For example, the presentation engine 340 may identify the media item entitled “Fast and Ferocious” as including the following descriptors: “action,” “cars,” and “blockbuster,” among others. The presentation engine 340 may identifying common descriptors between the media items “The New Show” and “Fast and Ferocious” and associate “Fast and Ferocious” with “The New Show,” such that user activity data 332 associated with “Fast and Ferocious” may be used in determining a likelihood that a particular user will want to consume “The New Show” when it becomes available. The processing device may search the media item catalog of the media system server 110 to determine one or more media items that may share the greatest number of factors or descriptors in common with a new media item that is to be launched on the media system server 110.

At operation 906, the media system may collect pre-availability data describing user interactions with pre-availability elements associated with the first media item. The pre-availability elements may be still images, videos, UI elements associated with such still images, videos, or a watchlist. The pre-availability elements may be accessible to a set of users of the media system during an intermediate period of time prior to the first media item becoming accessible to the set of users. The pre-availability elements may be trailers or promotional images that are associated with the first media item and are intended to make users of the media system aware that the first media item is scheduled to become available and to encourage those users to consume the media item when it becomes available. The users may be able to interact with the pre-availability elements by selecting them in a user interface, like the user interface 500, or by consuming them via the user device 502.

At operation 908, a processing device of the media system server 110 may determine a likelihood that a first user of a set of users will consume the first media item. The determination may be based on the second media item and the collected pre-availability data collected as part of the operation 906. For example, the presentation engine 340 may utilize user activity data 332 associated with “Fast and Ferocious” (which the presentation engine 340 determined to be related to or similar to “The New Show” in some respects) to generate likelihoods or probabilities associated with the set of users. The set of users may then be sorted into a ranking based on the likelihood of each user, like the rankings 600 shown in FIG. 6. Additionally, the user activity data 332 may include user interactions with pre-availability elements, such as a clip from “The New Show,” a trailer for “The New Show,” etc. The user activity data 332 may include user interactions with the pre-availability elements and intermediate period and a post-launch or availability period. The user activity data 332 may include information indicating which pre-availability elements have been presented to a particular user as well as any interactions the user has made with those pre-availability elements. In some embodiments, the user activity data 332 may be updated continuously, while in other embodiments, the user activity data 332 may be updated periodically, such as daily. Accordingly, the rankings 600 may be updated continuously or periodically as well.

At operation 910, a processing device of the media system may transmit a message promoting the first media item to a user device of the first user based on the likelihood and/or if the user is among the users of the targeted group. For example, the server 300 or the media system server 110 may send information to be rendered by the user device 502 in the user interface 500. In other embodiments, the message may be transmitted via email, SMS, or a push notification. The message may include an interactive link, a button, other UI elements, text, images, clips, trailers or another media item. For example, the message may include a pre-availability element 506 as shown in FIG. 5. As another example, the message may include presenting the underlying media item in the list 514 of recommended media items. In some embodiments, a UI element associated with a recommended media item may further include an indicator to highlight the upcoming availability or highlight the recent availability of that recommended media item. As shown in FIG. 5, the recommended media item #4 includes an indicator 516. The indicator 516 may be another example of a message that may be transmitted by the media system server 110 to the user device 502, which renders the message in the user interface 500. Such messages may be displayed in connection with the underlying media item whether it is included in the graphical user interface 500 as a promoted media item or as a listed media item in the watchlist 512. These and other messages may be transmitted by the media system server 110 to users in the target group and/or the reach group. Specific messages may be used to target these groups, due to their differing likelihoods of consuming the underlying media item being promoted by the messages.

The presentation engine 340 may continue to collect data describing user interactions with pre-availability elements and with the transmitted messages even after launch of the underlying media item, i.e. the availability period. The likelihoods associated with each user in the ranking 600C of FIG. 6 may be updated regularly or dynamically during the availability period based on user interactions with pre-availability elements and/or transmitted messages.

Embodiments of the presently disclosed systems and methods described herein permit a media system, whether a download-based media system or a streaming media system, to promote original media items that have not been made available outside of the media system. The systems and methods may enable to media system to optimize for targeting accuracy while also seeking to broaden the reach to beyond the group of users determined to be most likely to enjoy the media item.

Certain aspects of the present disclosure are set out the following numbered clauses:

1. A method comprising: associating descriptors of a first media item in a media item catalog of an Internet-based media system, the first media item having a play count about zero; identifying, by a processing device of the Internet-based media system, a second media item having a non-zero play count, the second media item being associated with at least one of the descriptors of the first media item; collecting pre-availability data describing user interactions with pre-availability elements associated with the first media item, the pre-availability elements being accessible to a set of users of the media system during an intermediate period of time prior to the first media item becoming accessible to the set of users; determining, based on the second media item and the collected pre-availability data, a likelihood that a first user of set of users will consume the first media item; and transmitting a message promoting the first media item to a user device of the first user based on the likelihood.

2. The method of clause 1, wherein the pre-availability data describing user interactions with pre-availability elements associated with the first media item comprises streams of a promotional video associated with the first media item to the user device, selections on a representational image of the first media item, and/or searches including a title of the first media item.

3. The method of any of clauses 1 and 2, wherein the pre-availability data comprises requests of individual users of the set of users to include the first media item on user-specific watchlists.

4. The method of any of clauses 1-3, wherein transmitting the message promoting the first media item comprises transmitting a promotional video associated with the first media item, a representational image of the first media item, and/or a text-based message identifying the first media item to the first user for rendering in a user interface on the user device.

5. The method of any of clauses 1-4, further comprising collecting availability period data describing user interactions with the first media item during an availability period of time.

6. The method of any of clauses 1-5, further comprising collecting additional information describing user interactions with the pre-availability elements during an availability period of time subsequent to the intermediate period of time, and wherein determining the likelihood is further based on the additional information.

7. The method of any of clauses 1-6, further comprising: collecting information describing an interaction of the first user with the message promoting the first media item; determining, based on the second media item, the collected pre-availability data, and the collected information describing the interaction of the first user with the message, a likelihood that a second user of the set of users will consume the first media item; and transmitting a message promoting the first media item to a user device of the second user based on the likelihood.

8. The method of any of clauses 1-7, wherein the first user of the set of users has a rank in a ranking of the set of users.

9. The method of any of clauses 1-8, wherein the ranking identifies a first subset of users that have likelihood of consuming the first media item that is greater than a threshold value and a second subset of users that have a likelihood of consuming the first media item that is less than the threshold value, wherein the first media item is to be presented to the first subset of users and to the second subset of users differently based on the threshold value.

10. The method of any of clauses 1-9, wherein the ranking further identifies a third subset of users to whom the first media item is not to be presented.

11. The method of any of clauses 1-10, wherein the ranking is updated a plurality of times before the first media item becomes available.

12. The method of any of clauses 1-11, wherein the set of users is a jurisdictionally-defined subset of a global set of users of the media system.

12.1 A non-transitory computer-readable storage medium storing instructions that, when executed by one or more processing devices, cause the processing devices to perform any of the features recited in any of clauses 1-12

12.2 A computing system that, when implemented by one or more processing devices, performs operations providing any of the features recited in any of clauses 1-12.

13. A method comprising: collecting pre-availability data describing user interactions in an Internet-based media system with pre-availability elements associated with a first media item, the pre-availability data being accessible to a set of users of an Internet-based media system during an intermediate period of time prior to the first media item becoming accessible to the users; determining, based the collected pre-availability data, a likelihood that each user of the set of users will consume the first media item after the first media item becomes accessible; and transmitting a message promoting the first media item to a user device of a first user of the set of users based on the likelihood.

14. The method of clause 13, wherein determining the likelihood that each user of the set of users will consume the first media item is further based on interactions of each user of the set of users with at least one related media item.

15. The method of any of clauses 13-14, further comprising modeling a consumption rate of the first media item by the set of users.

16. The method of any of clauses 13-15, further comprising generating a ranking of the set of users based on the likelihood that each user will consume the first media item.

17. The method of any of clauses 13-16, further comprising presenting a promotional media item to the set of users based on the ranking of the set of users, wherein subsets of the set of users are presented the promotional media item at different rates based on the ranking of the set of users.

18. The method of any of clauses 13-17, further comprising: collecting availability period data describing user interactions with the first media item after the first media item becomes accessible to the users; updating the likelihood that each user of the set of users that has not already consumed the first media item will consume the first media item; and transmitting the message promoting the first media item based on the updated likelihoods.

18.1 A non-transitory computer-readable storage medium storing instructions that, when executed by one or more processing devices, cause the processing devices to perform any of the features recited in any of clauses 1-18.

18.2 A computing system that, when implemented by one or more processing devices, performs operations providing any of the features recited in any of clauses 1-18.

19. An Internet-based media system for providing media items to user devices of a set of users, the system comprising: a data storage system storing, the data storage system storing user activity data for the set of users of the system, the user activity data describing interactions of the user devices with one or more media items of a set of media items in a media item catalog and with pre-availability elements associated with a first media item having a play count of zero; and a processing device in communication with the data storage system to access information about the first media item and the user activity data, wherein the processing device performs operations comprising: collecting pre-availability data describing user interactions in the Internet-based media system with pre-availability elements associated with the first media item, the pre-availability data being accessible to a set of users of the system during an intermediate period of time prior to the first media item becoming accessible to the set of users; determining, based the collected pre-availability data, a likelihood that each user of the set of users will consume the first media item after the first media item becomes accessible to the set of users; and transmitting a message promoting the first media item to a first user device of a first user based on the likelihood.

20. The system of clause 19, wherein the processing device performs operations further comprising: generating a ranking of the set of users based on the likelihood that each user will consume the first media item, and wherein transmitting the message promoting the first media item to the user device of the first user comprises transmitting the message based on the ranking of the first user of the set of users, wherein subsets of the set of users are presented with the message at different rates based on the ranking of the set of users.

20.1 A non-transitory computer-readable storage medium storing instructions that, when executed by one or more processing devices, cause the processing devices to perform any of the features recited in any of clauses 19-20.

20.2 A method that, when implemented by one or more processing devices, performs operations providing any of the features recited in any of clauses 19-20.

Although the foregoing aspects of the present disclosure have been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

1. A method comprising:
associating descriptors of a first media item in a media item catalog of an Internet-based media system, the first media item having a play count about zero;
identifying, by a processing device of the Internet-based media system, a second media item having a non-zero play count, the second media item being associated with at least one of the descriptors of the first media item;
collecting pre-availability data describing user interactions with pre-availability elements associated with and representative of the first media item, the pre-availability elements being accessible to a set of users of the media system during an intermediate period of time prior to the first media item becoming accessible to the set of users;
determining, based on the second media item and the collected pre-availability data, a likelihood that a first user of set of users will consume the first media item; and
transmitting a message promoting the first media item to a user device of the first user based on the likelihood.

2. The method of claim 1, wherein the pre-availability data describing user interactions with pre-availability elements associated with the first media item comprises streams of a promotional video associated with the first media item to the user device, selections on a representational image of the first media item, and/or searches including a title of the first media item.

3. The method of claim 1, wherein the pre-availability data comprises requests of individual users of the set of users to include the first media item on user-specific watchlists.

4. The method of claim 1, wherein transmitting the message promoting the first media item comprises transmitting a promotional video associated with the first media item, a representational image of the first media item, and/or a text-based message identifying the first media item to the first user for rendering in a user interface on the user device.

5. The method of claim 1, further comprising collecting availability period data describing user interactions with the first media item during an availability period of time.

6. The method of claim 1, further comprising collecting additional information describing user interactions with the pre-availability elements during an availability period of time subsequent to the intermediate period of time, and wherein determining the likelihood is further based on the additional information.

7. The method of claim 1, further comprising:
collecting information describing an interaction of the first user with the message promoting the first media item;
determining, based on the second media item, the collected pre-availability data, and the collected information describing the interaction of the first user with the message, a likelihood that a second user of the set of users will consume the first media item; and
transmitting a message promoting the first media item to a user device of the second user based on the likelihood.

8. The method of claim 1, wherein the first user of the set of users has a rank in a ranking of the set of users.

9. The method of claim 8, wherein the ranking identifies a first subset of users that have likelihood of consuming the first media item that is greater than a threshold value and a second subset of users that have a likelihood of consuming the first media item that is less than the threshold value, wherein the first media item is to be presented to the first subset of users and to the second subset of users differently based on the threshold value.

10. The method of claim 9, wherein the ranking further identifies a third subset of users to whom the first media item is not to be presented.

11. The method of claim 8, wherein the ranking is updated a plurality of times before the first media item becomes available.

12. The method of claim 1, wherein the set of users is a jurisdictionally-defined subset of a global set of users of the media system.

13. A method comprising:
collecting pre-availability data describing user interactions in an Internet-based media system with pre-availability elements associated with and representative of a first media item, the pre-availability data being accessible to a set of users of an Internet-based media system during an intermediate period of time prior to the first media item becoming accessible to the users;
determining, based the collected pre-availability data, a likelihood that each user of the set of users will consume the first media item after the first media item becomes accessible; and
transmitting a message promoting the first media item to a user device of a first user of the set of users based on the likelihood.

14. The method of claim 13, wherein determining the likelihood that each user of the set of users will consume the first media item is further based on interactions of each user of the set of users with at least one related media item.

15. The method of claim 13, further comprising modeling a consumption rate of the first media item by the set of users.

16. The method of claim 15, further comprising generating a ranking of the set of users based on the likelihood that each user will consume the first media item.

17. The method of claim 16, further comprising presenting a promotional media item to the set of users based on the ranking of the set of users, wherein subsets of the set of users are presented the promotional media item at different rates based on the ranking of the set of users.

18. The method of claim 13, further comprising:
collecting availability period data describing user interactions with the first media item after the first media item becomes accessible to the users;
updating the likelihood that each user of the set of users that has not already consumed the first media item will consume the first media item; and
transmitting the message promoting the first media item based on the updated likelihoods.

19. An Internet-based media system for providing media items to user devices of a set of users, the system comprising:
a data storage system, the data storage system storing user activity data for the set of users of the system, the user activity data describing interactions of the user devices with one or more media items of a set of media items in a media item catalog and with pre-availability elements associated with a first media item having a play count of zero; and
a processing device in communication with the data storage system to access information about the first media item and the user activity data, wherein the processing device performs operations comprising:
collecting pre-availability data describing user interactions in the Internet-based media system with pre-availability elements associated with and representative of the first media item, the pre-availability data being accessible to a set of users of the system during an intermediate period of time prior to the first media item becoming accessible to the set of users;
determining, based the collected pre-availability data, a likelihood that each user of the set of users will consume the first media item after the first media item becomes accessible to the set of users; and
transmitting a message promoting the first media item to a first user device of a first user based on the likelihood.

20. The system of claim 19, wherein the processing device performs operations further comprising:
generating a ranking of the set of users based on the likelihood that each user will consume the first media item, and
wherein transmitting the message promoting the first media item to the user device of the first user comprises transmitting the message based on the ranking of the first user of the set of users, wherein subsets of the set of users are presented with the message at different rates based on the ranking of the set of users.
